(19) United States
(12) Patent Application Publication
(10) Pub. No.: US 2012/0022813 A1
(43) Pub. Date: Jan. 26, 2012

(54) END USER ELECTRICITY NETWORK, USE, METHOD AND ASSEMBLY

(75) Inventor: Martinus Johannes Maria Van Riet, Arnhem (NL)

(73) Assignee: LIANDON B.V., Duiven (NL)

(21) Appl. No.: 13/145,953

(22) PCT Filed: Jan. 27, 2010
(86) PCT No.: PCT/NL10/50037

§ 371 Date: Oct. 7, 2011

(30) Foreign Application Priority Data
Jan. 27, 2009 (NL) 2002457

(51) Int. Cl. G06F 19/00

(52) U.S. Cl. 702/62

(57) ABSTRACT

An end user electricity network, connected to an electricity transmission cable via a main circuit breaker includes a primary part having a calibrated electrical meter that measures an amount of electricity consumed in the network, and a secondary part connected to the primary part that includes network parts connected electrically in parallel to each other in the network. The primary part further is provided with at least one first current sensor which is arranged to measure a total current running through the primary part.

The invention relates to an end user electricity network, connected to an electricity transmission cable via a main circuit breaker, wherein the end user electricity network is provided with a primary part comprising a calibrated electricity meter to measure an amount of electricity consumed in the network, and a secondary part connected to the primary part, comprising network parts connected electrically parallel in the network.

Such an end user network is generally known and is set up, for example, in and/or near a building, for example a dwelling, to provide end user devices with low voltage (or to receive electricity from one or more end user devices). A starting point of such a local network often comprises a meter cupboard, where a main transmission cable (for example of a public utility company) comes in. The main transmission cable is connected to the main circuit breaker, which is normally provided with a main fuse and is normally manually operable. The main circuit breaker serves as a protection, and is arranged to render the end user network dead. The breaker can automatically interrupt an electrical coupling between the network and the main transmission cable, in particular when the network loading exceeds a particular value. Further, the main circuit breaker may be operated to render the network dead when work is to be carried out on the network.

An above-mentioned amount of electricity consumed in the end user network is normally a positive consumption, for example, when only electricity-consuming devices are connected to the network.

Alternatively, for example, one or more electricity-generating devices may be coupled to the secondary part of the end user network. In that case, there may also exist a situation of a negative total electricity consumption (i.e., when locally more electricity is generated than is consumed). In that case, an end user network can serve as a supplier of electricity to the transmission cable.

The calibrated main meter is normally set up before or behind the main circuit breaker. The meter is arranged for measuring the total electricity consumption in the end user network, under the influence of the total current that runs from or to the main cable, through the meter and respective main circuit breaker. Diverse variants of calibrated electricity meters are known, including both analog and digital types. The electricity meter normally indicates the consumption in kWh, and has a maximum measuring inaccuracy of 2%, more particularly 1%.

Further, the end user network is normally provided with a number of parallel network parts (also called groups), which are connected via a distribution system to the main circuit breaker (whether or not via the calibrated meter). Diverse circuit breakers, for example fuses and/or earth leakage circuit breakers, may be provided to render these network parts dead individually. The parallel network parts are designed to carry the electricity to desired take-off locations (for example, in and/or near the building) (and/or to receive electricity therefrom when using local electricity generation), for example to sockets, appliances, and the like.

An advantage of the known network is that the calibrated electricity meter mentioned can register the cumulative electricity consumption very accurately. A disadvantage is that the meter is little flexible and, for example, does not give a reading of an instantaneous electricity consumption or of a consumption during a particular period of time. In many cases, for example, an old-fashioned analog meter is provided. Replacement of the analog meters with “smart digital meters” can at least partly remove the disadvantages mentioned, but such a replacement is particularly costly and time consuming, and results in a large amount of discarded meters.

Further, it is found that the known network may be overloaded, when different high-power devices connected to the network (for example, an automatic washing machine and vehicle accumulator) are switched on simultaneously and consume electricity. The overload may lead to unwanted blowing of a main fuse of the main circuit breaker.

The present invention contemplates an improved end user electricity network, where the above-mentioned disadvantages are at least partly removed, preferably utilizing relatively simple and also sufficiently safe means.

To this end, the network according to the invention is characterized by the features of claim 1.

The primary part is further provided with at least one first current sensor which is arranged to measure a total current running through the primary part.

The extra current sensor offers a large number of advantages. According to a further elaboration, the current sensor may, for example, be safely placed in an existing end user network, in order to provide a network according to the invention. Placement can be done safely in that the sensor is set up behind the main circuit breaker, at a network part from which the voltage can be simply temporarily removed.

The installed current sensor can provide a current measurement of a total current which, via the calibrated meter, is supplied to the end user network (in case of a positive total local electricity consumption) or is received therefrom (in case of a negative total local electricity consumption). The sensor can be made of relatively simple and inexpensive design. The sensor may in itself have a lower measuring accuracy than the calibrated meter mentioned.

Preferably, measurements carried out by means of the current sensor, after placement, are associated with a particular meter reading of the calibrated meter already present. A consumption measurement carried out by the calibrated meter at a particular time (i.e., the meter reading of that meter at that time) can be used, for example, as a reference point in processing current measurements carried out by the sensor (in order to calibrate a meter reading to be provided by the processing, on the basis of the instantaneous meter reading of the calibrated meter). To this end, in particular, the processing unit is designed to use at least one measurement carried out by the calibrated meter as a reference point (in processing current measurements carried out by the first sensor).

Preferably, a measuring signal delivered by the sensor is processed, for example, to determine a consumption in kWh (or other electricity consumption unit). For the purpose of determining electricity consumption, preferably also an associated local network voltage is measured. Further, the sensor may be used as part of an additional network protection system, for example to anticipate unwanted blowing of a main fuse upon overloading.

According to a particularly advantageous elaboration, the network is provided with a processing unit, which is associated with the current sensor mentioned to process a current measurement carried out by the sensor. The processing unit may contain, for example, electricity consumption reference data (i.e., calibration data), (in particular coming from the calibrated meter), to relate a current measurement carried out by the current sensor to a measurement carried out by the calibrated meter (i.e., to associate it therewith, to calibrate it thereagainst). Optionally, reference data provided by the calibrated meter may be regularly inputted into the processing unit (for example, one or more times a month, or one or more times a year).

The processing unit and associated current sensor may in themselves constitute an “intelligent electricity meter”. In particular, the processing unit and associated current sensor form a reference meter of the calibrated meter. For example, at a particular measuring time the thus formed reference meter gives substantially the same meter value (for example an instantaneous electricity consumption reading) as the calibrated electricity meter (at the same measuring time), by utilization of the reference (measuring) data mentioned.

The processing unit may, for example, be connected to a communication network, for example a computer network, to send data (for example, calibration data, measuring data, and the like) to a data processor located remote from the end user network (for example, of an electricity supplier). Further, the processing unit may, for example, receive data via the communication network, for example, software updates, information concerning electricity rates and the like.

According to an extra advantageous elaboration, at least one of the network parts is provided with a second current sensor, to measure current running in that network part. It is then particularly advantageous when the processing unit is also associated with the second current sensor to process a current measurement carried out by that sensor.

In this way, via the processing unit, a very extensive monitoring of the local end user network can be obtained. The processing unit obtains via the various current sensors both data concerning a total network current consumption and data concerning the consumption in one or more branches of the network. The various measuring data coming from the different current sensors can be processed by the processing unit, for example, to determine instantaneously where high network loadings (for example, by an active washing machine and/or an active vehicle accumulator) are taking place.

Also of great advantage is the further elaboration where at least one of the network parts is provided with a secondary circuit breaker, which circuit breaker is controllable by the processing unit.

Thus, the processing unit can automatically shut off one or more network parts (for example, temporarily), for example if the processing unit has determined the presence of, or a chance of, network overloading. To this end, the processing unit may be arranged, for example, to control a secondary circuit breaker as mentioned, depending on a result of a measurement carried out by at least one first and/or second current sensor mentioned.

According to a further elaboration, the local end user network is provided with one or more electricity sources, e.g., a local generator, a combined heat and power installation, an accumulator, and/or the like. In that case, it is advantageous when the processing unit is arranged to switch on one or more of the electricity sources, for example, if the processing unit has determined the presence of, or a chance of, network overloading.

A second current sensor as mentioned and a secondary circuit breaker as mentioned may, for example, be part of the same network-connectable unit.

According to a further elaboration, the second current sensor and secondary circuit breaker are each set up near the processing unit, for example, in a meter cupboard.

Another user-friendly embodiment comprises, for example, a device provided with a plug to be plugged into a socket to receive and/or supply electricity, which device has a socket output which is electrically coupled to the plug, where the electric coupling between the plug and output is provided with both a current sensor and a secondary circuit breaker as mentioned.

Another embodiment comprises a device provided with a plug to be plugged into a socket to receive and/or supply electricity, which device has a socket output which is coupled electrically to the plug, where the electric coupling between the plug and output is provided with a current sensor.

Another embodiment comprises a device provided with a plug to be plugged into a socket to receive and/or supply electricity, which device has a socket output which is coupled electrically to the plug, where the electric coupling between the plug and output is provided with a local circuit breaker controllable by the processing unit.

Existing end user networks can be adapted relatively easily and safely to provide a network according to the present invention.

The invention provides an assembly, apparently intended and arranged for providing an end user electricity network according to any one of claims 1-18, wherein the assembly is characterized in that it is provided with:
at least one said first current sensor; and
the processing unit, for processing a current measurement carried out by the first sensor.

As mentioned, the processing unit is associated in particular with the current sensor to process a current measurement carried out by the sensor, wherein the processing unit is arranged for processing of the measurements carried out by the first current sensor, utilizing one or more reference measuring data provided by a calibrated electricity meter. The assembly may be deployed with (i.e., added to) an existing calibrated electricity meter (already installed at an end user) to form a reference meter of the calibrated meter (for example, a local “intelligent electricity meter”).

Advantageous further elaborations of the assembly include, for example, at least one circuit breaker controllable by the processing unit, and/or at least one second current sensor, which is/are placeable in a branched-off network part of the end user network.

The assembly may, for example, be supplied in combination with a high-power device, for example, a vehicle accumulator or the like. In this way, the high-power device may be provided with electricity via the end user network, and/or supply electricity to the end user network. The assembly, after being installed in the network, can offer one or more of the advantages mentioned, for example, protection, data exchange and the like.

Further, the invention offers a method for the transmission of current via an end user electricity network, wherein the network is provided with a primary network part connected to an electricity transmission cable, which primary part is provided with a main circuit breaker to shut off the remaining part of the end user network from the transmission cable, as well as a calibrated electricity meter to measure an amount of electricity consumed in the end user electricity network, wherein the end user electricity network is provided with a secondary part connected to the primary part, comprising network parts connected electrically parallel in the network to link up end user devices.

Preferably, at least one first current sensor is placed in the primary network part, the sensor being used to measure the current running through the calibrated electricity meter.

Preferably, the calibrated electricity meter provides one or more reference measuring data (for example, at one or more reference measuring times). A processing unit may be provided to form together with the sensor a reference meter of the calibrated meter (for example, an “intelligent electricity meter”), utilizing the reference measuring data provided by the calibrated electricity meter.

In this manner, the above-mentioned advantages can be achieved.

The invention will presently be further elucidated on the basis of a non-limiting exemplary embodiment and the drawings. In the drawings:

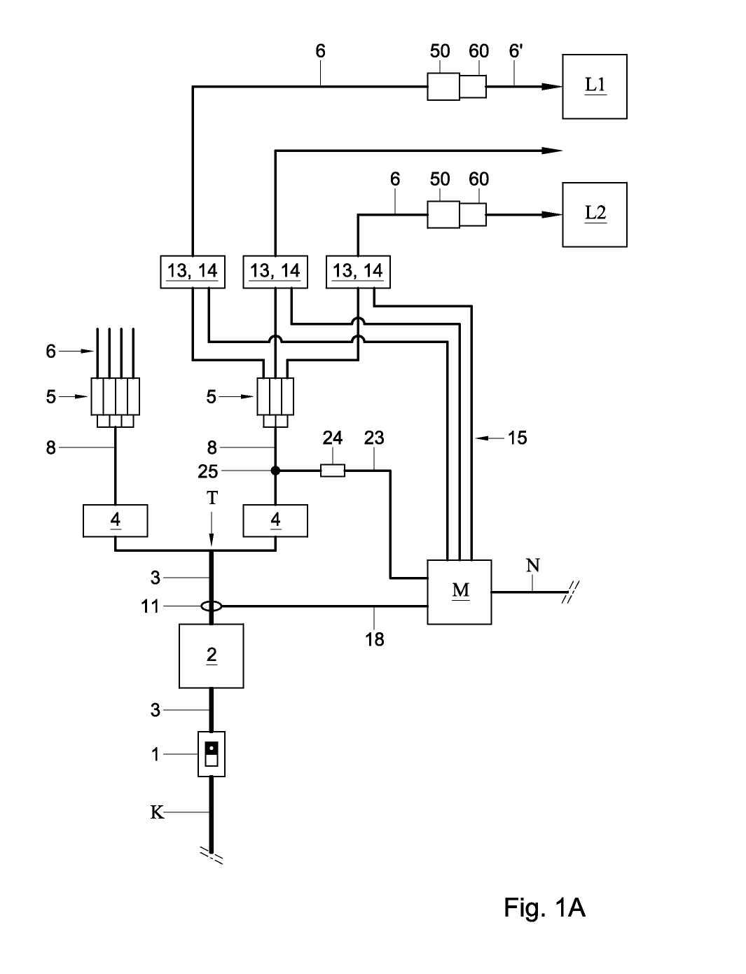

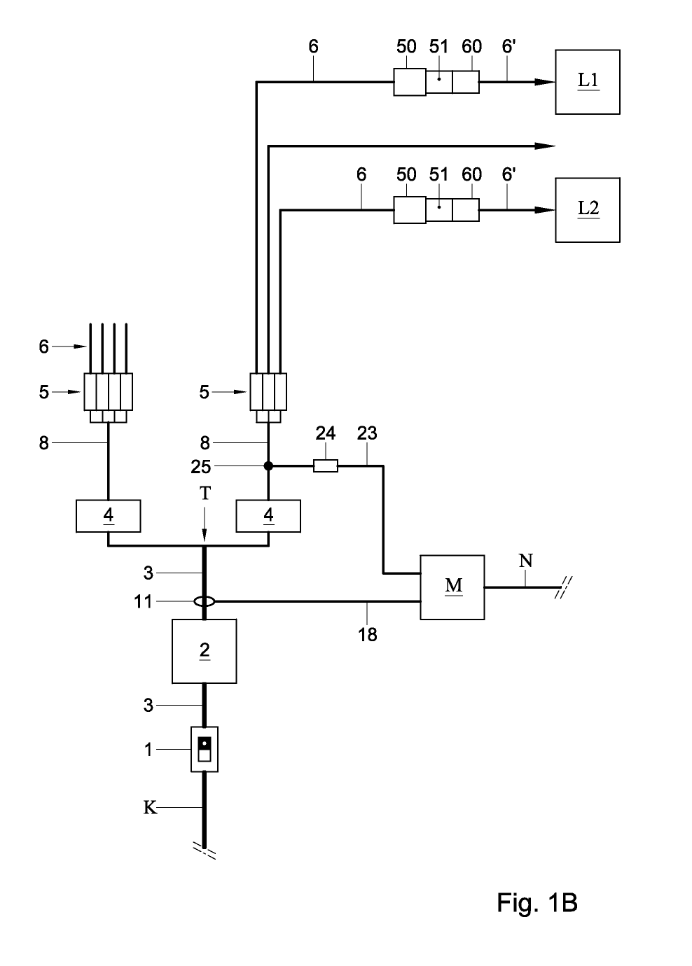

FIG. 1A schematically shows an exemplary embodiment of the invention;

FIG. 1B shows a similar drawing to FIG. 1A, of an alternative embodiment;

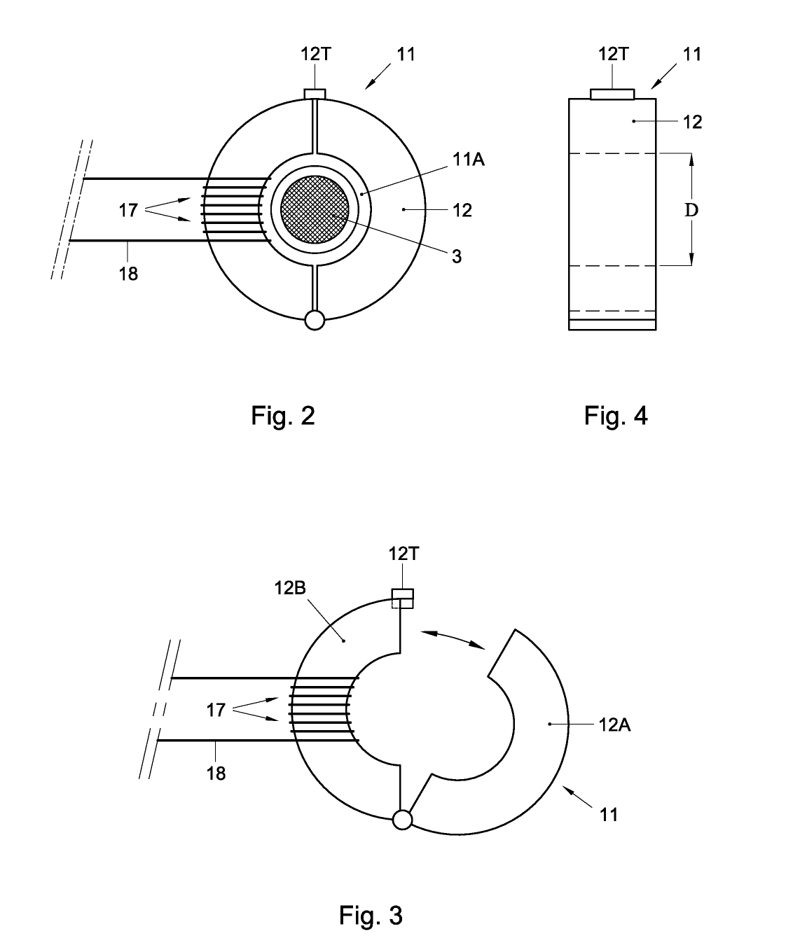

FIG. 2 shows a cross-sectional view of a part of the example shown in FIGS. 1A, 1B, in a closed sensor position;

FIG. 3 shows a similar view to FIG. 2, in an open sensor position;

FIG. 4 shows a side elevation of the sensor example shown in FIGS. 2-3;

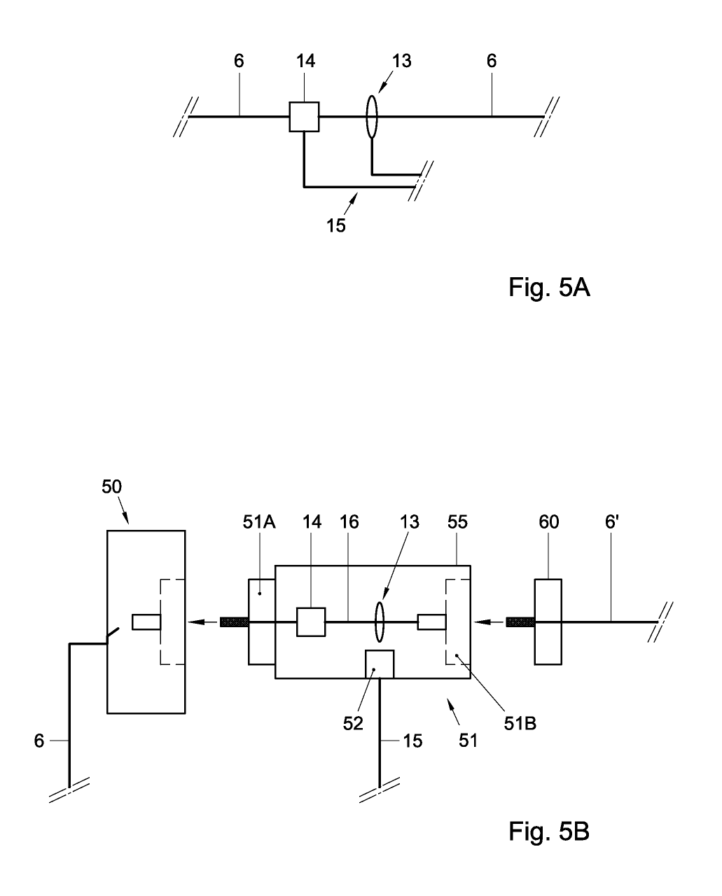

FIG. 5A schematically shows a first example of a measuring and control unit and

FIG. 5B schematically shows a second example of a measuring and control unit.

The same or corresponding features in this application are designated by the same or corresponding reference signs.

FIGS. 1A, 1B schematically show examples of a local end user electricity network, for example to provide a building (such as a dwelling or office) with electricity and/or to receive electricity therefrom. The electricity to be supplied and/or received comprises in particular low voltage (for example, 110V, or 220-230V, alternating voltage).

A primary part 1, 2, 3 of the end user network is connected to an electric cable K of an electricity supplier. Such a cable K is typically provided with different current conductors, viz., one or more phase conductors (which are live, to supply and/or receive the electricity), and a neutral conductor (for a return current).

The connection of the network to the cable K proceeds via a network protection station 1 of the primary network part, comprising a main circuit breaker. This breaker preferably comprises a switch which is manually switchable between a current passing position and a current interrupting position, to allow and to interrupt, respectively, an electric connection between transmission cable K and the secondary part of the network.

Further, network protection station 1 is provided with a main fuse, which may be situated, for instance, in a sealed box. This fuse is arranged to automatically interrupt current supply to the end user network when a current running via the fuse exceeds a particular threshold value. A known type of main fuse needs to be replaced when it has jumped to a circuit breaking position under the influence of overloading.

In the schematically depicted example, network protection station 1 is represented as a single part, but the station may also comprise separate parts, for example a part that comprises a main circuit breaker and another part that comprises the main fuse.

Usually, it is desired to measure the current consumption (for example, in kWh) of the end user network. To this end, the primary network part is provided with a calibrated, usually sealed, electricity meter (main meter) 2. All current that flows between the main cable K and a secondary part 5, 6, 8 of the end user network, to or from end user devices L1, L2 connected to the network, runs via the main meter 2, in order that the meter can register the total consumption. The main meter 2 may be designed in different manners, for example based on the eddy current principle (Ferraris sensor), and may be analog or digital.

It is noted that each end user device L1, L2 may be designed to consume current, to supply current, or both. An end user device that generates current may be designed in different manners, for example, comprising a generator, a combined heat and power installation, an accumulator, and/or the like.

In the example, the main meter 2 is set up behind the protection station 1, but a reverse order is also possible. Further, the main meter 2 may be situated, for example, between a main fuse and main circuit breaker when those components are set up separately from each other.

The network comprises a secondary part, with secondary (electricity-receiving and/or electricity-supplying) network parts 6 included electrically parallel in the network (to provide the same low voltage), which are set up behind protection station 1 and the calibrated meter 2. During use, different end user devices L1, L2 may be connected to these secondary network parts 6, for example via respective current conductors 6′ (provided with plugs 60 in the drawing), to receive and/or locally supply current. Usually, a distribution system T, 4, 5 is provided, to branch off the primary network part into the several secondary network parts 6. The distribution system can comprise, for example, one or more earth leakage switches 4, and network switches 5 for each of the network parts 6 to be separately rendered dead and protected.

The present primary network part comprises a primary phase conductor 3, provided with a branch (current distributor) T to secondary phase conductors 8 (in this case two), provided with earth leakage switches 4. Each of the earth leakage switches 4 is coupled to a respective (electrically parallel) series of secondary network parts 6, via respective switches 5. The switches 5 may in themselves be provided with, for example, fuses, automatics and the like.

End user devices may be, for example, current consumers, and comprise, e.g., lighting, electric appliances and the like. In this example, two high-power devices L1, L2 are represented, e.g., a washing machine L1 and vehicle accumulator L2.

Furthermore, end user devices can comprise, for example, one or more local current producers, which are coupled to the secondary network parts 6 to supply current to them. An example of such a local current supplier may be, for example, an accumulator as mentioned, or another device, e.g., a combined heat and power system, generator, turbine and/or the like.

Usually, the secondary network parts 6 are provided with one or more sockets 50 to detachably receive plugs of end user device power cables, for linking up the respective end user device.

Operatively current-carrying primary phase conductors 3 are provided, to couple the network to one or more phase conductors of the main cable K. In the implementation of a single-phase current (as is represented in the drawing), all secondary network parts 6 are coupled to the same phase conductor of the main cable K, via one or more primary phase conductors 3, the main meter 2 and the protection station 1.

In addition, polyphase current, for example 3-phase high-voltage current, may be used. In the latter case (not shown), the cable K supplies (or receives) different current phases, which are passed via respective different primary phase conductors 3 to the network parts 6 (or vice versa, are removed therefrom, in case of local generation of electricity).

Each primary phase conductor 3 can comprise, for example, electric wire or cable 3, provided with a phase-conducting core and an insulation sheath (see FIG. 2). In the example, a primary phase conductor 3 is provided to couple the main circuit breaker and main meter 2 to each other. Further, a primary phase conductor 3 extends to the branch T mentioned, to be branched into the secondary phase conductors 8.

For the simplicity of the drawing, only phase conductor portions (which during normal use are under the low voltage mentioned) are represented. Neutral conductors (not shown) are provided, to form a neutral circuit, which is connected to the neutral conductor of the main cable K (as is generally known, the voltage in the neutral circuit during normal use is typically about 0 V).

Advantageously, the network is provided with at least one first current sensor 11 (separate with respect to the calibrated meter 2) which, in series with respect to the calibrated electricity meter 2, is set up, for example, behind the main circuit breaker mentioned and before the branch T. The at least one first current sensor 11 is arranged to measure a total current running via the electricity transmission cable K. An example of the first sensor 11 is represented in FIGS. 2-4.

In the use of single-phase current, for example, only one first sensor 11 may be provided. The first sensor 11 is arranged on a primary phase conductor 3, to measure the current passed therethrough. In this manner, via the sensor 11 the total current consumption of the end user network can be determined. As the current measured by sensor 11 is also the current that is used by the main meter 2 to measure the total electricity consumption, the sensor measurement can simply be calibrated against the measurement carried out by the main meter 2.

In the use of polyphase current, for each of the phases a separate first sensor is provided, in order that the sensors jointly can measure the total current. In such a polyphase configuration, the main meter 2 is arranged to measure the total electricity consumption, based on each of the different phases supplied via primary conductors 3.

In the example, the first sensor 11 is positioned, with respect to the main meter 2, on a side coupled to the secondary network part. Alternatively, the sensor may be set up on the other side with respect to the main meter 2, in particular between main meter 2 and the main switch mentioned.

As shown in more detail in FIGS. 2-4, each current sensor 11 may be provided, for example, with a transformer core 12 which includes a passage 11A for passing therethrough an electrical conductor 3 of the end user electricity network, and with a coil with a number of sensor conductor turns 17 arranged on the core, with a signal output (provided with signal conductors 18) to deliver a sensor signal. In the example, the core 12 has an annular shape, with a circular inner circumference and a circular outer circumference. The core of the sensor may also be differently shaped, for example, elliptic, angular, square. The sensor may further comprise a housing, not shown, in which the core 12 is accommodated. Preferably, the conductor 3 can be received in the sensor passage 11A with relatively little clearance, for example, less than 1 mm. A diameter D of the core passage 11A is, for example, 1 cm, or less.

During use, an alternating current running through conductor 3 can generate a magnetic flux in the core 12, under the influence of which flux the coil turns 17 generate the sensor signal. The sensor signal is, for example, proportional to a current running through conductor 3. Preferably, the core 12 is made of ferrite, so that a relatively compact and sufficiently sensitive sensor can be obtained.

The core 12 is designed to be arranged on the conductor 3 in an open position, and thereupon to be closed for the purpose of sensing a magnetic field. FIG. 3 shows an open position and FIG. 2 shows a closed position of the sensor 11. In the example, the sensor is provided with core parts 12a, 12b hingedly coupled to each other. Alternatively, the core parts 12a, 12b may, for example, be detachably coupled to each other, in the closed core position, and be mutually apart in the open position. Preferably, means are provided to lock the core 12 in the closed position, for example, a clamped coupling, Velcro connection, threaded coupling means, a pin joint, or the like. The example comprises a snap connection 12 T between the core parts 12A, 12B, to keep the parts in the closed position.

Furthermore, a processing unit M is provided, which is associated with the current sensor 11 to process a current measurement carried out by the sensor 11. In the example, the processing unit is coupled to the current sensor via the sensor signal conductors 18, to receive the measuring signal directly. Alternatively, the first sensor 11 and processing unit M may, for example, be coupled via a communication connection (which may or may not be wireless) to exchange data concerning the measurements carried out by the sensor 11.

The processing unit M may be designed in different manners, for example, comprising hardware, software, a microcontroller, computer, a memory, calculating means, a supply, for example via a feeder cable 23 connected to the secondary network part, and/or the like.

According to a further elaboration, the processing unit M is provided with a branch cable 23 couplable to a network phase conductor part, to receive and measure local network voltage (which is associated with a current measured by the first sensor 11). In the use of three-phase current, processing unit M is preferably provided with three respective branch cables, to receive and measure the three corresponding local voltages. Preferably, a branch cable also serves as feeder cable, to supply processing unit M, but this is not essential.

A branch cable 23 (for example, feeder cable) may be coupled to the network in different manners, and to different locations of the network. Preferably, branch cable 23 is coupled to the network near a respective first sensor.

According to an advantageous embodiment, a branch cable 23 is coupled to a network part that is situated between the secondary switches 5 and network protection station 1, in particular to measure network voltage as well. In the example, the branch cable 23 is provided with an insulated branch terminal 25, to branch off electricity from a phase conductor 8. Preferably, an overload protection, for example, a current limiter or a fuse 24, is provided to protect processing unit M from short-circuiting. In the example, this protection 24 is part of the branch cable 23. Further, the branch cable 23 may be provided with a neutral conductor which is coupled, via a second branch terminal, not shown, to a secondary neutral conductor of the network (in itself not shown).

The processing unit M is preferably arranged to carry out various functions, comprising in particular, overload protection, network energy consumption measurement, and communication with an external data processing station (not represented) and/or a local computer terminal (not represented) related to the end user network.

Preferably, the processing unit M is connected to at least one communication network N, for example the Internet, to send data to a data processor remote from the end user network. As mentioned, it is advantageous, for example, when the processing unit M is remotely controllable via such a communication network N, for example for receiving data via the communication network, for example software updates, information concerning electricity rates, offers, and the like. Connection of the data processor M to a communication network may be implemented in different manners, for example, via wired and/or wireless communication links. The data processor M is, for example, coupled to a local computer network, for example to a Local Area Network (LAN), a local wireless network (e.g., WIFI), or the like, which is associated with the end user network. The data processor M may be arranged, for example, to distribute information in a local computer network and/or receive data from a local computer network.

According to a further elaboration, the processing unit M is arranged for, on the basis of the current measurement carried out by the sensor 11 (and information concerning a network voltage), measuring an amount of electricity consumed in the end user electricity network (for example, a power in kWh). To this end, the processing unit M can make use of, for example, predetermined data, for example a low voltage, and sensor data to calculate from a sensor signal the current strength of a current flowing through phase conductor 3.

Preferably, a voltage meter is provided, to measure the low voltage mentioned. The processing unit M may, for example, itself be provided with such a voltage meter, be connected to an external voltage meter, or be designed in a different manner to measure the voltage in the network. In the example, processing unit M receives a local network voltage via a branch cable 23. The processing unit M is arranged to measure the voltage received via branch cable 23, and in particular to use the measured voltage and the current measured via the first sensor 11 to determine an instantaneous electricity consumption.

Preferably, the processing unit M is arranged for calibration of the first current sensor 11. The processing unit M has available, for example, predetermined calibration data, for example a calibration table, calibration parameters and/or a calibration formula, to be able, on the basis of a sensor signal delivered by the sensor 11, to determine relatively accurately the current intensity and/or an electricity consumption derived from the current intensity.

According to a preferred embodiment, the processing unit M is arranged for processing the measurements carried out by the first current sensor 11, utilizing reference measuring data provided by the calibrated electricity meter 2 (i.e., the processing unit M is calibrated on the basis of calibration data furnished by the meter 2). The reference data (i.e., calibration data) can comprise, for example, one or more measuring results carried out by the calibrated meter 2, alone or in combination with associated measuring times. The processing unit M can use the reference measuring data in different manners, for example to form together with the sensor 11 a digital (“smart”) reference meter (of the calibrated meter 2). Preferably, the processing unit M is arranged to relate the current measurements (and associated voltage measurements) carried out by the first sensor to the reference measurement(s) provided by the calibrated meter, in particular such that the processing unit M and the calibrated meter 2 provide instantaneously substantially the same value of the cumulative electricity consumption (of the end user). Calibration of the processing unit-sensor assembly M, 11 (on the basis of the values provided by the calibrated meter 2) is preferably carried out periodically, for example at least once a year or more often.

It is then extra advantageous when such reference measuring data provided by calibrated meter 2 can be inputted, for example, by inputting the data in a memory of the processing unit M. The processing unit M may be provided, for example, with a user interface, for example a keyboard, display, computer network unit, and/or the like, to change calibration data. According to a further elaboration, processing unit M may be approachable, for example through a computer communication network, to change such data.

Preferably, the processing unit M is deigned to determine whether a total current instantaneously consumed by the end user electricity network reaches or exceeds a first threshold value, utilizing measuring data of first current sensor 11. In this manner, extra protection against overloading can be obtained. A threshold value as mentioned may be, for example, a current intensity of 35 amperes, 50 amperes, or other value. Preferably, the threshold value is dynamic, in particular time-dependent. The dynamic threshold value is, for example, a current per unit time. The processing unit M may be designed, for example, to temporarily allow a particular peak current (for example, for a number of seconds or minutes), depending on the height of the peak current. In a non-limiting example, a peak current of 35 amperes is tolerated by processing unit M for a peak period of 10 minutes at a maximum, and, for example, a peak current of 50 A for a peak period of 5 seconds at a maximum. When the peak period is exceeded, the processing unit M can decide that the first threshold value has been reached (and that overloading is present).

Optionally, processing unit M may, for example, deliver an alert signal if the unit M has determined that the first threshold value is reached or exceeded.

Further, the processing unit M is preferably arranged to store current measurement data, or information derived from such data, periodically (for example, with a period of one or a few minutes, an hour, a day, or otherwise).

In the present network, the processing unit M can also monitor current consumption in secondary network parts. In this manner, the processing unit M can, for example, localize where a high-power device is active.

Preferably, at least one of the secondary network parts 6 is provided with a second current sensor 13, to measure current running in that network part 6. The processing unit M is associated with each second current sensor 13 to process a current measurement carried out by that sensor 13.

A few second current sensors 13 are shown in FIGS. 1A, 1B. Further embodiments of such a sensor are represented in FIGS. 5A, 5B.

The second current sensor 13 may be implemented in different manners. A particularly advantageous second current sensor 13, for example, has a configuration identical or similar to a first current sensor 11. A second current sensor 13 may be provided, for example, with a transformer core which includes a passage for passing therethrough a secondary electric conductor of the end user electricity network, and with a number of sensor conductor turns arranged on the core, with a signal output (provided with signal conductors) for delivering a second sensor signal. During use, an alternating current running through the secondary conductor can generate a magnetic flux in the core, under the influence of which flux the turns generate the second sensor signal. Preferably, a transformer core of a second sensor is made of ferrite. A core of a second current sensor 13 may be designed, for example, to be arranged in an open position on a secondary conductor and thereupon to be closed for the purpose of sensing a magnetic field.

In the present example, the various secondary network parts 6 are provided with sockets 50, for coupling thereto plugs 60 of end user devices for the purpose of current supply and/or local current reception. A socket 50 may, for example, be fixed to a building, or be part of a loose extension cord.

FIGS. 1A, 5A show an example in which the second current sensor 13 is set up near the processing unit M, for example behind a switch 5 (and, for example, in a meter cupboard). The second sensor 13 is arranged to measure the current flowing via secondary phase conductor part 16. Each second sensor 13 is coupled to the processing unit M via a respective signal connection 15, to send a respective second measuring signal to the unit M. The sensor 13 can instantaneously monitor all current running via the respective secondary conductor part 6.

FIGS. 1B, 5B show an alternative where the second current sensor is part of a separate measuring device 51 which is detachably couplable to a socket 50. This device is provided, for example, with a housing 55, comprising a plug part A capable of being plugged into a socket 50 to receive or supply current, and a secondary contact part B (for example, a socket of its own) to deliver or receive the current received or supplied via plug part A (for example, to/from a plug 60 of an end user device conductor 6′, plugged into part B). Alternatively, the measuring device 51 may, for example, be already integrated with an end user device conductor 6′. In that case, a secondary contact part B may be omitted.

Socket measuring device 51 comprises, for example, a secondary phase conductor part 16, to carry current from plug part A to end user device conductor 6′ (for example, via the secondary contact part B), or to carry it away therefrom (if the respective end user device is a current generator). A second sensor 13 is provided to measure the current flowing via secondary phase conductor part 16. The present measuring device 51 may be simply used in combination with already existing socket systems, between a plug and an end user network socket 50.

Each measuring device 51 is coupled to the processing unit M via a respective communication connection 15, to send the second measuring signal, or information concerning that measuring signal, to that unit M. The latter communication connection can comprise, for example, a wired or wireless connection. The measuring device 51 may be provided, for example, with a local signal processor 52, for example an electronic circuit, a microcontroller or the like, for the purpose of local signal processing and/or communication with the processing unit M.

The measuring device 51 further comprises, for example, a neutral conductor (not shown) for a return current, and optionally an earth coupling (not shown), for example to ground an end user device L1, L2.

By the use of the measuring devices at sockets which supply current to high-power devices L1, L2, and/or receive current therefrom, the processing unit M can accurately, instantaneously, monitor the current consumption (i.e., energy consumption) of those user devices L1, L2.

According to an extra advantageous elaboration, one or more of the secondary network parts 6 are provided with a secondary circuit breaker 14, which circuit breaker is controllable by the processing unit M.

FIG. 5A schematically shows such a circuit breaker 14. In the examples, the secondary circuit breakers 14 are associated with the second current sensors 13. Control of the circuit breaker 14 can be done, for example, through control signals, capable of being sent by processing unit M to breaker 14 via a suitable signal connection 15.

FIG. 5B shows a further elaboration, in which a circuit breaker 14 is integrated with a respective housing of a measuring device 51. The measuring device 51 thus forms a measuring and switching unit. In this case, also, control of the circuit breaker 14 may be done, for example, through control signals, capable of being sent by processing unit M to breaker 14 via a suitable signal connection 15.

In an alternative embodiment, a secondary circuit breaker 14 is not part of a local (i.e., set up near an end user) measuring device 51. The end user electricity network may be provided, for example, with one or more secondary circuit breakers 14, and not with a local second sensor as mentioned. In such an embodiment, the secondary circuit breaker 14 may be set up near the processing unit M (for example, in a meter cupboard), or remote therefrom. In the latter case, a secondary circuit breaker 14 may be part of a circuit breaker unit, provided with a plug to be inserted into a socket 50, which circuit breaker unit has an electrical output to supply current (for example, to an end user device L1, L2) and/or receive current. In that case, the circuit breaker unit can comprise a secondary phase conductor, which is provided with the respective circuit breakers 14.

Each secondary circuit breaker 14 may be designed in different manners. In a non-limiting example, these circuit breakers 14 are each provided with a switch, for example relay, which is switchable to an interrupting position to interrupt a secondary phase conductor 16. The secondary circuit breaker 14 may be provided, for example, with a local signal processor, e.g., an electronic circuit, a microcontroller or the like, for the purpose of local signal processing and/or communication with the processing unit M.

Preferably, the processing unit M is arranged to control each secondary circuit breaker 14, depending on a result of a measurement carried out by at least one first current sensor 11. In the example, processing unit M is arranged to control secondary circuit breakers 14, depending on measuring results of both the first and second current sensors 11, 13.

Preferably, the processing unit M is arranged to control a secondary circuit breaker 14 to a current interrupting position when a first threshold value is reached or is exceeded. The first threshold value is associated, for example, to a second threshold value, being a main fuse threshold value.

The processing unit M can, for example, control all circuit breakers 14 to a current interrupting position as soon as the processing unit M, based on a first sensor signal, detects network overloading being present. Preferably, however, the switching off of secondary current, by processing unit M and circuit breakers 14, depends on the current measurements carried out by the second sensors 16. Thus, processing unit M may be arranged, for example, to control only one circuit breaker 14, or a part of the circuit breakers 14, to the current interrupting position in a network overload situation.

Use can comprise a method for supplying and/or receiving current to/from a number of end user devices L1, L2. The first sensor 11 measures the current running through the calibrated electricity meter 2 during the supply of the current to at least one or more of the end user devices L1, L2, and/or during the reception of current from end user devices L1, L2.

A current measured by the sensor 11 may be processed by processing unit M to prevent overloading of the network.

Furthermore, for example, a local voltage related to the measured current is measured, for example a voltage provided via branch cable 23 to processing unit M. A measured voltage is preferably used, together with the current measured by sensor 11, to determine an instantaneous electricity consumption.

Further, the current measured by sensor 11, or information derived from such a measurement (for example, an electricity consumption), may be periodically stored by the processing unit M (for example, with a period of one or a few minutes, an hour, a day, or otherwise).

In case of high-power devices, for example 15 amperes or more may be supplied to each of different end user devices L1, L2, or be received therefrom. In the use of high-power devices, the danger exists of overloading of the end user network, in particular the blowing of the main fuse 1.

Measuring data provided by the first sensor 11 can be processed to control at least one circuit breaker set up locally in the network. Furthermore, the measuring data provided by the first sensor 11 may be processed to prevent overloading of the main circuit breaker 1, for example, blowing of the main fuse.

As soon as the total current consumed by an end user network reaches or exceeds a first threshold value (which is instantaneously detected by the processing unit M utilizing measuring data from the first current sensor 11), the processing unit M takes action to prevent, or undo, the overloading. To this end, preferably, current supply to at least one of the end user devices L1, L2 is shut off, by controlling the respective secondary circuit breaker 14 to the current-interrupting position.

The processing unit M can take different parameters into account in deciding which of the circuit breakers 14 is to switch to a current-interrupting position if a first threshold value is reached. Thus, at least current may be (temporarily) shut off to an end user device that, according to measuring data from a respective second current sensor 13, has already been active for a relatively long period of time.

Further, current may be (temporarily) shut off to an end user device that, according to measuring data from a respective second current sensor 13, consumes a relatively high current intensity, for example, the end user device that consumes the highest current of all end user devices L1, L2.

If an end user device comprises an accumulator to be charged, charging may, for example, be carried out flexibly, for example time-dependently and/or dependently on an instantaneous total electricity consumption determined via first sensor 11.

In addition, different circuit breakers 14 may be assigned different priorities, the switching-off of a circuit breaker 14 then depending on the priority. In that case, current supply may first be shut off to an active (current consuming) end user device L1 that is coupled to a circuit breaker 14 which has been assigned a lowest priority. If shut-off of that end user device L1 is not sufficient to prevent network overloading, a next active end user device L2, which is coupled to a circuit breaker 14 that has been assigned a lowest-but-one priority, may be shut off, and so forth.

Clearly, various other parameters may be used in switching off local current supply.

According to an extra advantageous elaboration, processing unit M can also arrange for a switched-off current supply to be switched on, for example under the influence of a main current measurement carried out by the first current sensor 11, and optionally measurements carried out by one or more second sensors 13. In particular, a secondary circuit breaker 14 switched to a current-interrupting position may be controlled to a current passing position again when processing unit M determines, on the basis of the sensor measuring data, that such switching-on of current will not lead to network overloading (anymore).

In the above, use of electricity-consuming end user device L1, L2 has been mentioned. Such a device L1, L2 may further in itself be designed, for example, to supply current, for example if the device L1, L2 is an accumulator. Further, the local end user network may be provided, for example, with one or more electricity sources, which are specifically designed to locally generate and supply electricity, e.g., a local generator, windmill turbine, a combined heat and power installation, or the like. The first sensor can then measure the current during current supply by the source to the network.

A processing unit M may, for example, control the one or more electricity sources (for example, switching them on and off), depending on a measurement carried out by the first sensor 11. Then, an embodiment is extra advantageous in which an electricity source is associated with a second sensor, such that a current supplied by the source can be measured via the second sensor. As a result, the processing unit M can determine how much current (and energy, given a known, for example measured, associated voltage) the source provides.

To those skilled in the art it will be clear that the invention is not limited to the exemplary embodiments described. Various modifications are possible within the framework of the invention as set forth in the following claims.

For example, a measurement carried out by a first and optional second sensor may comprise, for example, measurement of a current intensity (for example in Ampere) through a conductor, a power related to the current intensity (for example, in Watt or kWh), and/or other type of measurement.

1-26. (canceled)

27. An end user electrical network connected to an electricity transmission cable via a main circuit breaker, the end user electrical network comprising:
a primary part comprising a calibrated electrical meter that measures an amount of electricity consumed in the network;
a secondary part connected to the primary part and comprising plural network parts connected electrically in parallel to each other in the network, wherein the primary part further comprises at least one first current sensor arranged to measure a total current running through the primary part; and
a processing unit operatively coupled to said first current sensor so as to process a current measurement carried out by the first current sensor by utilizing one or more reference measuring data provided by the calibrated electrical meter.

28. The network of claim 27, wherein the processing unit in combination with said first current sensor forms a reference meter of the calibrated electrical meter,
wherein the processing unit uses at least one measurement carried out by the calibrated electrical meter at a particular time as a reference point during processing of current measurements carried out by the first current sensor.

29. The network of claim 27, wherein the processing unit measures an amount of electricity consumed in the end user electrical network using current measurement carried out by the first current sensor.

30. The network of claim 27, further comprising an interface to the processing unit through which the processing unit is provided with said reference measuring data.

31. The network of claim 30, wherein the interface comprises a user interface.

32. The network of claim 30, wherein the interface comprises an interface to a computer communications network.

33. The network of claim 27, wherein the processing unit is connected to a communication network that sends data to a data processor located remote from the end user electrical network.

34. The network of claim 27, further comprising at least one current phase conductor arranged between the transmission cable and the parallel network parts, wherein the first current sensor is arranged on said at least one current phase conductor.

35. The network of claim 27, further comprising three current phase conductors situated between the transmission cable and a distribution station for transmission of three-phase current, wherein each of said three current phase conductors comprises one of said at least one first current sensor.

36. The network of claim 27, wherein each of said at least one current sensor comprises a transformer core having a passage with an electrical conductor of the end user electrical network passing therethrough, said transformer core comprising a plurality of sensor conductor turns arranged thereon.

37. The network of claim 36, wherein the transformer core comprises ferrite.

38. The network of claim 37, wherein the transformer core is arranged on the electrical conductor of the end user electrical network in an open position, said transformer core being arranged so as to be closed to sense a magnetic field.

39. The network of claim 27, wherein one of the plural network parts comprises a second current sensor that measures current flowing in said one of the network parts, wherein the processing unit is associated with said second current sensor so as to process a current measurement carried out by said second current sensor.

40. The network of claim 39, wherein the plural network parts comprise sockets, wherein said second current sensor is part of a device detachably coupled to one of the sockets.

41. The network of claim 27, wherein at least one of the plural network parts comprises a secondary circuit breaker operatively controlled by the processing unit.

42. The network of claim 41, wherein said secondary circuit breaker is part of a device detachably coupled to one of a plurality of sockets.

43. The network of claim 41, wherein the processing unit is arranged to control the secondary circuit breaker responsive to a result of a measurement carried out by at least one current sensor.

44. The network of claim 41, wherein the processing unit is arranged to control said secondary circuit breaker to move to a current-interrupting position when a first threshold value is reached or is exceeded.

45. The network of claim 27, wherein the processing unit is arranged to determine whether a total current instantaneously flowing through the end user electrical network reaches or exceeds a first threshold value by utilizing measurement data provided by the first current sensor.

46. The network of claim 45, further comprising a main fuse arranged to automatically interrupt a current supply to the end user electrical network when a current flowing through the main fuse exceeds a second threshold value, wherein said first threshold value is associated with the second threshold value.

47. A method of using the end user electrical network of claim 27, comprising measuring data provided by the calibrated meter and using the measured data as a reference for measurements carried out by the first sensor.

48. A method of using the end user electrical network of claim 27, comprising processing measurement data provided by the first sensor and controlling at least one circuit breaker arranged locally in the end user electrical network in response to the processed measurement data.

49. A method of using the end user electrical network of claim 27, comprising processing measurement data provided by the first sensor and preventing overloading of the main circuit breaker.

50. The method of claim 49, wherein said preventing overloading of the main circuit breaker comprises blowing a main fuse.

51. A method for transmitting electrical current via an end user electrical network, the method comprising:
providing a primary part, said primary part comprising a calibrated electrical meter that measures an amount of electricity flowing in the end user electrical network, and at least one first current sensor arranged to measure a total current running through the primary part;
connecting a secondary part to the primary part, said secondary part comprising plural network parts connected electrically in parallel to each other in the end user electrical network so as to link end user devices; and
operatively coupling a processing unit to said at least one first current sensor so as to process a current measurement carried out by the first current sensor by utilizing one or more reference measuring data provided by the calibrated electrical meter.
providing a processing unit which, together with said one first current sensor, forms a reference meter of the calibrated electrical meter by utilizing the reference measuring data provided by the calibrated electrical meter.

52. The method of claim 51, further comprising associating measurements carried out by the first current sensor with at least one particular meter reading of the calibrated electrical meter.

53. The method of claim 51, further comprising using a consumption measurement carried out at a particular time by the calibrated electrical meter as a reference point in processing of current measurements carried out by the first current sensor.

54. A measurement assembly for use in an end user electrical network, the assembly comprising:
at least one first current sensor; and
a processing unit arranged to process a current measurement carried out by the at least one first current sensor.

55. The measurement assembly of claim 54, wherein the processing unit is configured to send measurement data via a communication network to a data processor located remote from the end user electrical network.
